(19) United States
(12) Patent Application Publication
(10) Pub. No.: US 2002/0159128 A1
(43) Pub. Date: Oct. 31, 2002

(54) Mach-Zehnder optical modulator

(75) Inventor: Malcolm Green, Simsbury, CT (US)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: JDS Uniphase Corporation, San Jose, CA

(21) Appl. No.: 10/131,706

(22) Filed: Apr. 24, 2002

(30) Foreign Application Priority Data
Apr. 26, 2001 (GB) 0112048.2

(51) Int. Cl. G02F 1/03; G02F 1/07

(52) U.S. Cl. 359/245

(57) ABSTRACT

The present invention relates to a Mach-Zehnder optical modulator having an electrode structure that is arranged to compensate for temperature induced performance degrading variations. The distances between appropriate faces of the signal electrode and a ground electrode and corresponding wave-guide arms are arranged such that there is a more balanced thermal expansion of the waveguide arms due to heating of the waveguides by the RF signals carried on the signal and ground electrodes. Tailored buffer layers further balances the heating in the waveguide arms through the RF losses in the electrodes. The balanced heating reduces the temperature gradient between the waveguide arms of the optical modulator and hence reduces the adverse thermally induced performance degrading variations.

### FIELD OF THE INVENTION

The present invention relates to Mach-Zehnder optical modulators and, more particularly, to such optical modulator having reduced DC bias drift.

### BACKGROUND OF THE INVENTION

Electro-optic materials, such as lithium niobate, have refractive indices that vary according to the magnitude and direction of an applied electric field. The applied field leads to a change in refractive index which consequently produces a corresponding change in the propagation constant of any light passing through the crystal and in turn a change in the phase of the optical signal. An optical modulator, and, in particular, a Mach-Zehnder (MZ) optical modulator, typically comprises an input waveguide that is coupled to a pair of parallel waveguide arms. The refractive indices of the material from which the two arms are fabricated can be varied by applying appropriate electric fields to bring about changes in the velocity of propagation of the light through the arms. Controlling the applied electric fields to produce a phase difference between the signals propagating in the two arms results in varying degrees of constructive or destructive interference when the signals are recombined for output via an output waveguide which, in turn, leads to a modulated optical output signal.

Typically, MZ modulators are fabricated using a lithium niobate substrate. Lithium niobate exhibits a pyroelectric and a piezoelectric effect such that a change in temperature of a degree or more may be sufficient to affect adversely the operation of, in particular z-cut and to a lesser extent x-cut, Mach-Zehnder optical modulators. In effect, changes in ambient temperature can lead to a change in the optical properties of the waveguides.

Furthermore, due to the arrangement of the conductors which carry the applied modulating electric fields, differing regions of the optical modulator may operate at different respective temperatures. Any such temperature variation leads to differing degrees of local thermal expansion across the device and hence local variations in piezoelectric charge. The resulting physical length changes and changes in refractive index through piezo-optic and electro-optic effects leads to unequal changes in the optical path lengths of the waveguide arms. The above changes impair the operational performance of the Mach-Zehnder optical modulator by, for example, adversely effecting the extinction ratio.

Conventionally, any such temperature changes leading to optical path length differences are accommodated by changing the bias voltage. However, there is a limit to the extent to which the bias voltage can be used to compensate for such changes. The limit is determined by the resilience of the dielectric layer to an applied electric field and the separation of the ground and signal electrodes. At relatively high bias voltages, 30 V to 40 V, there is an increased risk of dielectric breakdown between the signal electrode and the ground electrodes. However, in practical embodiments, the maximum voltage for the bias electrode is limited by the voltage rail of the control circuitry in the optical communications system. The voltage rail is typically in the range of 10-20V.

It is an object of the present invention at least to mitigate some of the problems of the prior art.

It is an object of at least some embodiments of the present invention to reduce changes in optical performance that result from changes in the ambient temperature of the modulator.

### SUMMARY OF THE INVENTION

Accordingly, a first aspect of the present invention provides an optical modulator comprising an input waveguide and an output waveguide coupled by first and second waveguide arms, the first and second waveguide arms having an electrode structure, comprising at least three electrodes asymmetrically disposed relative to the first and second waveguides, at least two of the electrodes are positioned such the distance between a first electrode of the two electrodes and the first waveguide is substantially equal to the distance between a second electrode of the two electrodes and the second waveguide.

However, it has been found that changes in the ambient temperature during temperature testing to ensure compliance of operating parameters with stringent tests show the DC bias voltage to have an undesirable system response. Transients, which take the modulator out of specification, manifest themselves in response to a temperature change.

Therefore, a second aspect of the present invention provides an optical modulator comprising an input waveguide and an output waveguide coupled by first and second waveguide arms, the first and second waveguide arms having an electrode structure, comprising at least three electrodes asymmetrically disposed relative to the first and second waveguides, at least two of the electrodes are positioned such the distance between a first electrode of the two electrodes and the first waveguide is substantially equal to the distance between a second electrode of the two electrodes and the second waveguide and in which the first and second electrodes share a common buffer layer.

However, the presence of a continuous buffer layer provides an effective thermal path between the electrodes and the waveguides via which heat, generated by RF heating, can be conducted to the waveguides. Suitably, it is an object of at least some embodiments of the present invention to mitigate the effect upon the quadrature point of RF heating within the waveguides of the modulator.

Therefore, a third aspect of the present invention provides an optical modulator comprising an input waveguide and an output waveguide coupled by first and second waveguide arms, the first and second waveguide arms having an electrode structure, comprising at least three electrodes asymmetrically disposed relative to the first and second waveguides, at least two of the electrodes are positioned such the distance between a first electrode of the two electrodes and the first waveguide is substantially equal to the distance between a second electrode of the two electrodes and the second waveguide and in which the first and second electrodes are deposited on respective, separate, buffer layers.

Preferably, an embodiment provides an optical modulator in which the separate buffer layers overlap respective waveguides to different extents. In a preferred embodiment, the respective degrees of overlap are arranged to at least balance any heating within the waveguides which results from RF heating within the electrodes.

Advantageously, the third aspect represents a compromise between the first and second aspects, that is, the changes in ambient temperature are compensated, the transients in the DC bias voltage are at least reduced to an acceptable level and the effect of RF heating is at least reduced.

### BRIEF DESCRIPTION OF THE DRAWINGS

Embodiments of the present invention will now be described, by way of example only, with reference to the accompanying drawings in which:

FIG. 1 shows a plan view of a prior art Mach-Zehnder optical modulator;

FIG. 2 shows a sectional view of the prior art modulator shown in FIG. 1;

FIGS. 3 and 4 illustrate plan and sectional views of a Mach-Zehnder optical modulator according to a first embodiment of the present invention;

FIGS. 5 and 6 show plan and sectional views of a Mach-Zehnder optical modulator according to a second embodiment of the present invention; and

FIGS. 7 and 8 show plan and sectional views of a Mach-Zehnder optical modulator according to a third embodiment of the present invention.

### DETAILED DESCRIPTION

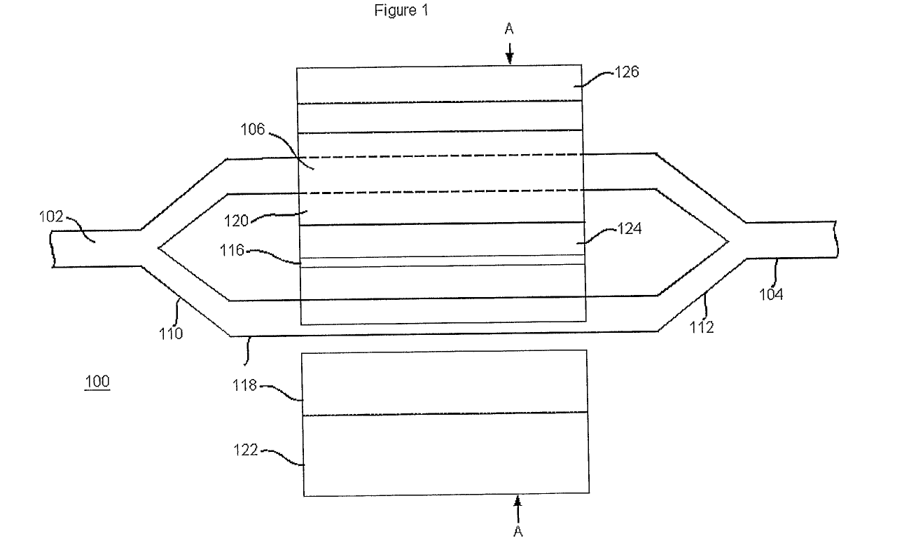

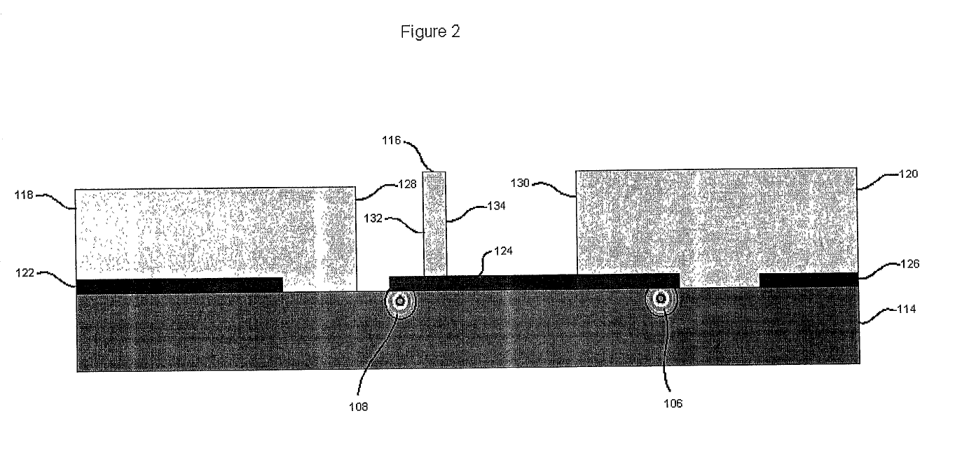

Referring to FIGS. 1 and 2 there is shown schematically a prior art Mach-Zehnder optical modulator 100 comprising an input waveguide 102, an output waveguide 104 having disposed therebetween two, preferably parallel, waveguide arms 106 and 108 that are coupled by respective divergent and convergent waveguide portions 110 and 112. The waveguides are formed on a lithium niobate substrate 114 by titanium diffusion. As is conventional, a signal electrode 116 is disposed between the two waveguide arms 106 and 108. Preferably, the signal electrode is asymmetrically disposed relative to the waveguide arms to effect a required chirp onto the modulated optical signal. The modulator also comprises outer ground electrodes 118 and 120 that, in use, form a push-pull arrangement to modulate the light output from the output waveguide 104. Disposed beneath the signal and ground electrodes are respective dielectric buffer layers 124, 122 and 126. The dielectric layer 124 can be seen to span both the signal electrode 116 and one of the ground electrodes 120. Both of the ground electrodes have first and second signal electrode-facing walls 128 and 130. Dimensions for the prior art modulator may take the following values. The distance between the inwardly facing walls 128 and 130 is between 35-45 μm. The distance between the first inwardly facing wall 128 and the opposing wall 132 of the signal electrode 116 is between 13-20 μm. The distance between the second inwardly facing wall 130 of the second electrode 120 and the opposing face of the signal electrode 134 is between 13-20 μm. The waveguide arms 106 and 108 are separated by a distance of 42 μm. The distance between the centre of the first waveguide arm 108 and the closest face 132 of the signal electrode 116 is 6 μm. The distance between the second waveguide arm 106 and the other face 134 of the signal electrode 116 can be calculated from the above dimensions.

It can be seen that the central dielectric layer 124 comprises a shoulder that extends from beneath the signal electrode 116 towards the first waveguide arm 108. The thickness of that central dielectric layer 124 shoulder is 1.2 μm and the width of the shoulder is 2-15 μm measured from the face 132 of the signal electrode. The distance between the second waveguide arm 106 and the inwardly directed face 130 of the second electrode 120 can be calculated from the above values.

The above prior art Mach-Zehnder optical modulator suffers from the problems outlined above. Temperature gradients within the modulator lead to both physical and optical path length differences, which affect adversely the performance of the device. In particular, the DC bias voltage must be modified to compensate for temperature induced performance degrading changes within the modulator.

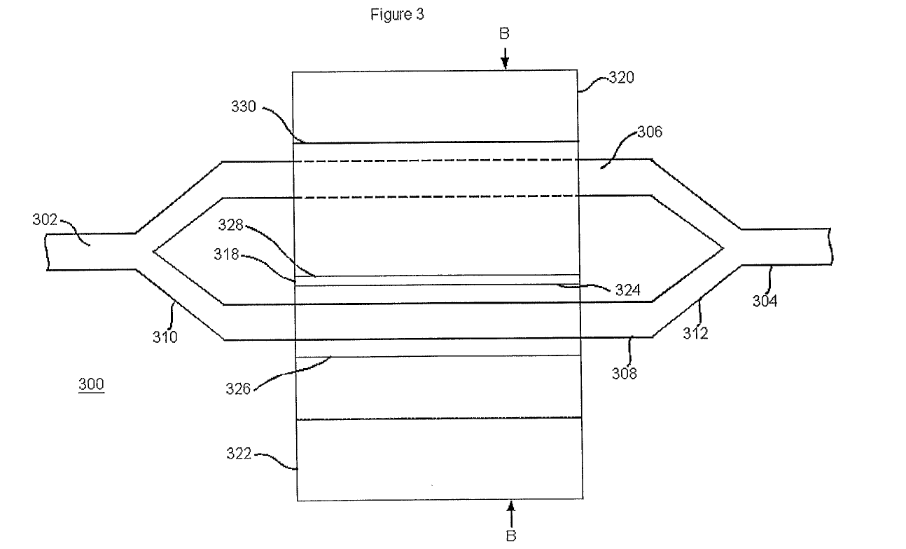

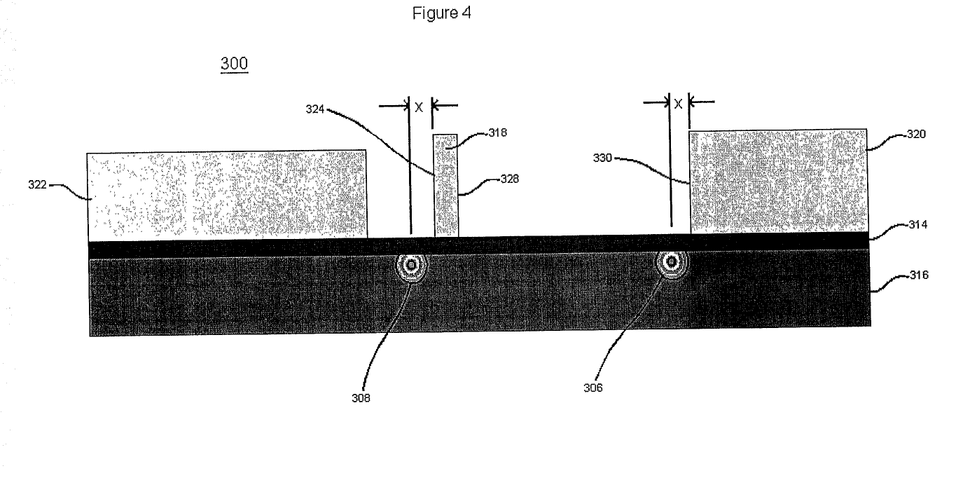

Referring to FIGS. 3 and 4 there is shown, in plan and sectional views respectively, a chirped Mach-Zehnder optical modulator 300 according to a first embodiment. The MZ modulator 300 comprises input 302 and output 304 waveguides connected to a pair of parallel waveguide arms 306 and 308 via respective Y-portions 310 and 312. Preferably, a dielectric layer 314, spanning or common to all electrodes and the parallel waveguide arms 306 and 308, is deposited on a lithium niobate substrate 316. A signal electrode 318 is asymmetrically disposed between the pair of waveguide arms 306 and 308. Two ground electrodes 320 and 322 are provided in respect of the waveguide arms 306 and 308 and disposed outwardly of the waveguide arms 306 and 308.

The waveguides are formed by titanium diffusion and over which are placed the dielectric and electrode layers thereby allowing the formation of a Ti:LiNbO₃ optical modulator. Preferably, the optical modulator is formed on a x-cut lithium niobate substrate.

Dimensions for an embodiment may take the following values. The distances between opposing faces of the signal electrode 318 and the ground electrodes 302 and 322 are between 40-60 μm and 10-15 μm. The first embodiment of the optical modulator operates using wavelengths in the range of 1300 to 1620 nm and, preferably, within the range of 1500 to 1620 nm. The modulator is driven with an electrical signal that forms a high bit rate data signal of sufficient amplitude to achieve the required extinction ratio of light at the bit rate.

The width of the signal electrode 318 is 6-8 μm. The distance between a first face 324 of the signal electrode and the opposing face 326 of the first ground electrode 322 is 10-15 μm. The distance between a second face 328 of the signal electrode 318 and the opposing face 330 of the second electrode 320 is 40-60 μm. The distance between the centre line of the signal electrode 318 and the centre of the first waveguide arm 308 is 10-15 μm. The distance between the centre of the second waveguide arm 306 and the inwardly directed face 330 of the second ground electrode 320 is the same as the corresponding distance between the inwardly directed face 324 of the signal electrode 318 and the centre of the first waveguide arm 308.

Without wishing to be bound by any particular theory, it is thought that matching the distances between the waveguide centres and the faces 324 and 330 of the signal and ground electrodes respectively results in substantially equal mechanical forces, generated from thermal expansion due to ambient temperature changes, acting on the waveguides. The equal mechanical stresses result in equal physical path lengths, or changes in path lengths, in the two waveguides and equal index changes from strain-optic and electro-optic effects from piezo-electric charge generation. The substantially equal mechanical and index impact on each waveguide results in a balanced change in the phase of the optical signal in each waveguide and thus a substantially reduced, and preferably no, relative change in phase between the two. This substantially reduced phase change gives a substantially reduced bias voltage required to correct for any such phase differences.

In an embodiment, the thickness of the electrodes is preferably 15-25 μm. The thickness of the dielectric layer 314 is preferably 1.2 μm. The dimensions of the cross-section of the waveguide arms are 3-7 μm and 5-8 μm. The length of the electrodes is 20-40 μm.

The first embodiment, with equal distances from electrode edges to waveguides, ensures that the waveguides experience equal thermal expansion and piezoelectric charging from ambient temperature changes. The first embodiment has the additional advantage that the continuous buffer at least reduces, and preferably, removes transients in the thermal response of the bias voltage.

In summary, it can be appreciated that the first embodiment is directed to reducing required DC bias compensation that results from changes in the ambient temperature of the device. This aim is addressed by appropriate placement of the gold electrodes with respect to the waveguides. The optional continuous buffer layer substantially reduces, and preferably removes, transients in the DC bias voltage that can occur during temperature changes.

However, it thought that the first embodiment will, due to the continuous buffer layer, efficiently couple heat generated by the RF signal in the signal electrode to the waveguides, which also adversely affects performance. Therefore, a second aspect of the present invention is arranged to address this problem.

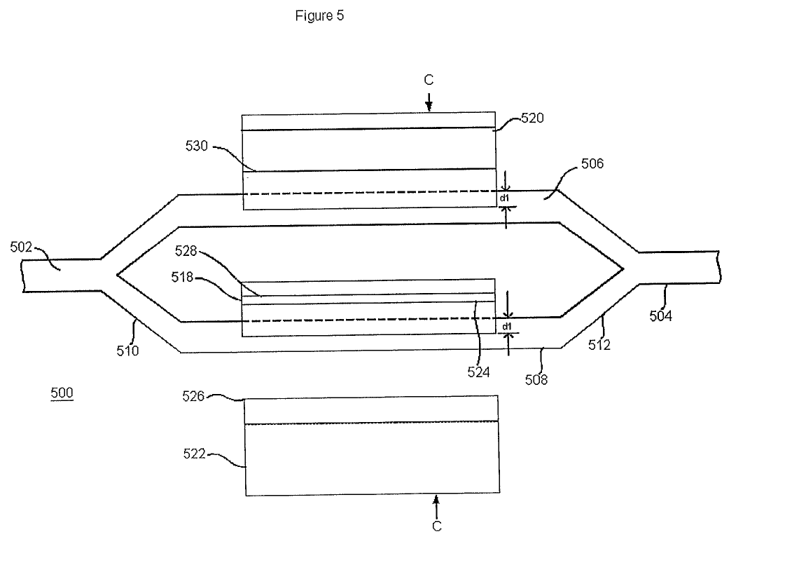

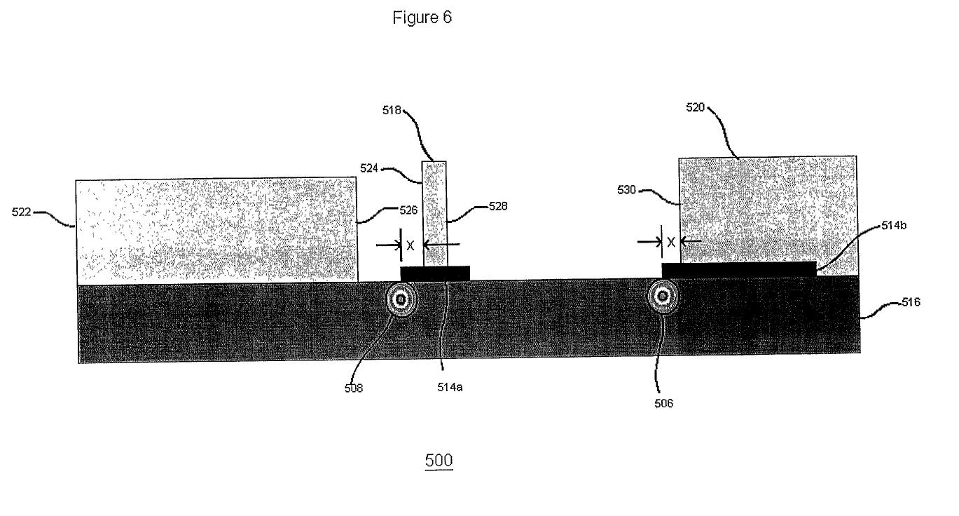

Suitably, referring to FIGS. 5 and 6 there is shown, in plan and sectional views respectively, a second embodiment of a Mach-Zehnder optical modulator 500 comprising respective input 502 and output 504 waveguides having connected therebetween a pair of parallel waveguide arms 506 and 508. The waveguide arms are connected to the input 502 and output 504 waveguides via respective divergent and convergent waveguide portions 510 and 512. A dielectric layer 514 is deposited on a lithium niobate substrate 516. A signal electrode 518 is disposed between the pair of waveguide arms 506 and 508. Two ground electrodes 520 and 522 are provided in respect of the waveguide arms 506 and 508 and disposed outwardly thereof.

Features of the second embodiment may have the following dimensions. The width of the signal electrode 518 is between 6-8 μm, and is preferably 6 μm. The distance between a first face 524 of the signal electrode and the opposing face 526 of the first ground electrode 522 is between 10-15 μm, and is preferably 13.5 μm. The distance between a second face 528 of the signal electrode 518 and the opposing face 530 of the second electrode 520 is between 40-60 μm and is preferably 55 μm. The distance between the centre line of the signal electrode 518 and the centre of the first 508 waveguide arm is 12 μm which gives a distance between the centre of the first waveguide 508 and the first face 524 of the signal electrode 518 of 9 μm. The distance between the centre of the second waveguide arm 506 and the inwardly directed face 530 of the second ground electrode 520 is the same as the corresponding distance between the inwardly directed face 524 of the signal electrode 518 and the centre of the first waveguide arm 508.

The thickness of the electrodes is preferably 15-25 μm. The thickness of the dielectric layer 514 is preferably 1.2 μm. The dimensions of the cross-section of the waveguide arms are 3-7 μm and 5-8 μm.

The second embodiment, which as can be appreciated, is a reduced buffer embodiment, that is, the buffer is not continuous across the device. The reduced buffer embodiment has the advantage that one of the ground electrodes 522 can be deposited directly on the niobate substrate and thereby reduce V, while allowing for a larger gap between the signal electrode 518 and the ground electrode 522 to reduce microwave losses. It will be appreciated that RF heating arises from resistive losses in the electrodes and presents an additional source of heating to the ambient temperature changes that are addressed by the first embodiment. In the second embodiment, the discontinuous buffer reduces the degree of thermal coupling between the electrodes and the waveguides which assists in mitigating the effect of RF heating within the waveguides.

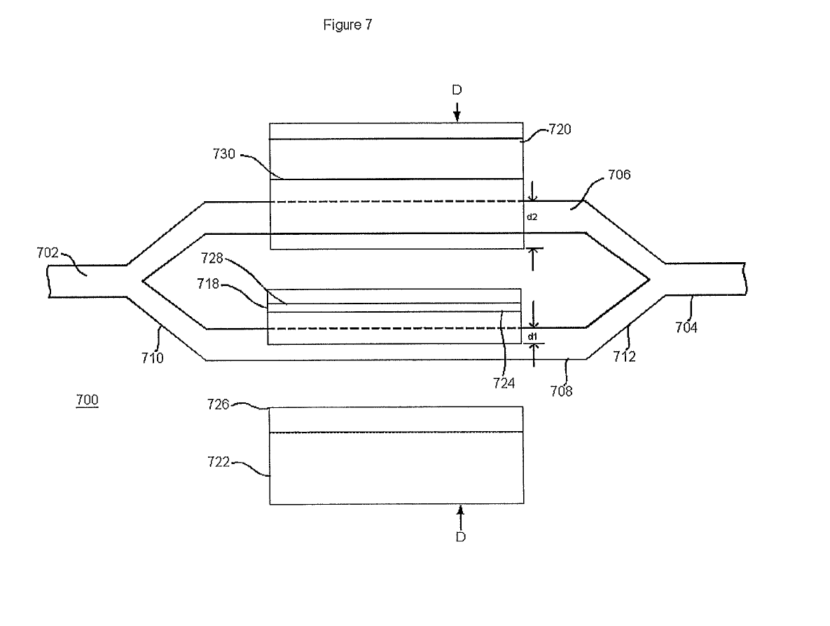

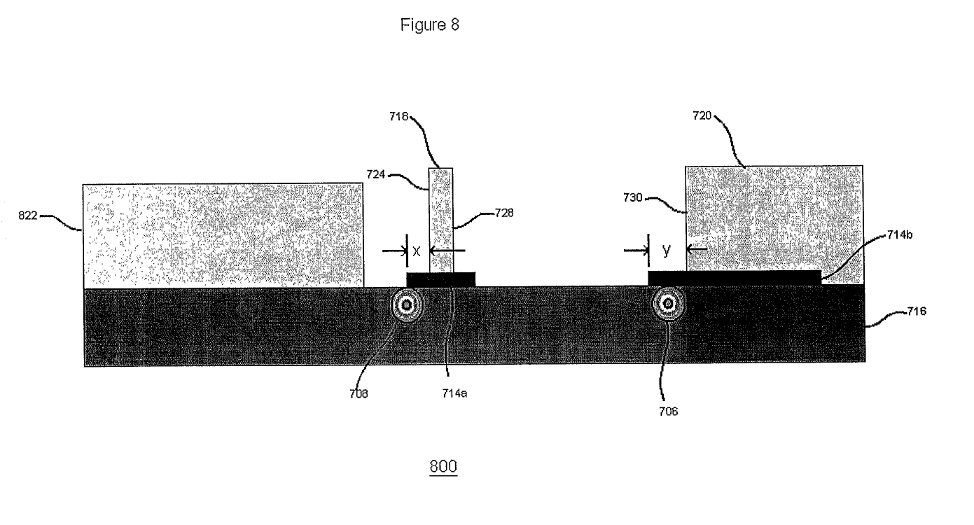

Referring to FIGS. 7 and 8, there is shown a third embodiment of a MZ modulator 700. Within the third embodiment, the distances from the buffer edges or dielectric layer shoulders to respective waveguide arms are arranged so as to balance the influence of the RF heating upon the waveguide arms. Preferably, the degree of overlap of the buffers 714a and 714b with respective waveguide arms 708 and 706 is arranged to balance the effect of RF heating within the waveguides. In a preferred embodiment, the degree of overlap of the buffer layers 714a and 714b is substantially unequal. In a preferred embodiment, the widths, x and y, of the shoulders of the buffer layers 714a and 714b are such that x<y. In an embodiment, preferably, x is 5 μm. In a further or the same embodiment, preferably, y is 9 μm.

It is thought that the combination of the matching distances between the inwardly directed walls 524 and 530 of the signal electrode 518 and ground electrode 520 to the corresponding waveguide centres and the substantially balanced degree of RF thermal heating resulting from the respective degrees of buffer overlap with respective waveguides results in substantially equal thermal expansion of the waveguides and hence improved optical performance.

As the variation in optical performance of the embodiments is reduced significantly, the corresponding variations in DC biasing to compensate for any such variation in optical performance is also reduced.

Therefore, in the third embodiment, the matched thermal heating leads to substantially equal physical thermal expansion in the waveguide arms. In effect, the thermal path between the waveguide and the electrodes is arranged to ensure that matched thermal conditions prevail.

Furthermore, the piezo and pyroelectric effects within the lithium niobate substrate surrounding the waveguides, in the proximity of the inwardly facing walls 724 and 730, is, again, substantially equal which maintains the desired phase relationships between the light propagating down the first 708 and second 706 waveguide arms. It will be appreciated that an advantage of the second embodiment is that a reduction in the change of DC bias applied to the electrodes with changing ambient temperature can be realised. Due to the temperature matching, the degree of change in the DC bias required to maintain preferred operating conditions is mitigated. It can be appreciated that preserving the desired phase relationship, that is, by mitigating the adverse effect of thermal expansion and/or the piezo and pyroelectric effect, leads to improved constructive and destructive interference and an improved extinction ratio of the light output from the output waveguide 504.

As can be appreciated from FIGS. 7 and 8, the dielectric layer 714 comprises first 714a and second 714b portions that are disposed beneath the signal electrodes 718 and 720. Preferably, the distance between the centre of the waveguides 508 and 506 and the inwardly facing walls 724 and 730 of the signal electrode 718 and ground electrode 720 are substantially unequal in contrast to the second embodiment in which the degree of overlap is equal.

It will be appreciated that the tailoring the degree of overlap of the buffer layers 714a and 714b with the respective waveguides results in substantially equal thermal coupling of heat generated by RF heating to the waveguides.

In a preferred embodiment, the distance from a first face 524 of the signal electrode to the closest waveguide, that is, to the left-most waveguide 708, is 12 μm. In addition, the distance between the second waveguide 706 and an inwardly directed face 730 of the ground electrode 720 is 4.7 μm. In effect, the degree of overlap between the buffers and the waveguides is unequal.

However, the principal additional advantage of the third embodiment over the second embodiment is that by adjusting the widths of the buffer shoulders, the thermal path between electrode and waveguide is altered to balance the heating caused by the RF signals carried in the electrodes. It will be appreciated that the signal electrode will be the hottest. However, some heating will also arise in the ground electrode. Therefore, by tailoring the thermal paths the RF based heating of the waveguides can be substantially equalised. It will also be appreciated that in reducing the buffer shoulders, increased transient response to ambient temperature changes of the required bias voltage will be incurred. It is the intention of this embodiment to arrive at a suitable buffer shoulder width that adjusts the transient reduction of the second embodiment (shown in FIGS. 5 and 6) with the RF heating reduction of this embodiment, to come to a suitable compromise of both parameters.

In effect, the buffers in the third embodiment are arranged such that, for a given temperature of signal and ground electrode, the thermal coupling between the signal electrode and a respective closest waveguide is less than the thermal coupling between the ground electrode and a respective closest waveguide at that given temperature.

Although the above embodiments have been described with reference to x-cut lithium niobate, the embodiments of the present invention are not limited thereto. Embodiments can equally well be realised which use z-cut lithium niobate. One skilled in the art will appreciate that the position of the electrodes for z-cut LiNbO₃ would be different as compared to the above x-cut embodiments.

What is claimed is:

1. An optical modulator comprising an input waveguide and an output waveguide coupled by first and second waveguide arms, the first and second waveguide arms having an electrode structure, comprising at least three electrodes asymmetrically disposed relative to the first and second waveguides, at least two of the electrodes are positioned such the distance between a first electrode of the two electrodes and the first waveguide is substantially equal to the distance between a second electrode of the two electrodes and the second waveguide.

2. An optical device as claimed in claim 1 in which the at least two electrodes share a common buffer layer.

3. An optical modulator as claimed in claim 1, in which the at least two electrodes are deposited on respective, separate, buffer layers.

4. An optical modulator as claimed in claim 3 in which the distance between the waveguides and the shoulders of buffer layers of respective closest electrodes of the two electrodes is such that substantially equal thermal coupling between the waveguides and the two electrodes is achieved.

5. An optical modulator as claimed in claim 4, in which the distances between the waveguides and the shoulders of the buffer layer of the respective electrodes are substantially unequal.

6. An optical modulator as claimed in claim 4 in which the buffer layer shoulder width of the buffer layer of the first electrode has a width of substantially 7-14 μm, preferably 12 μm.

7. An optical modulator as claimed in claim 6 in which the buffer layer of the second electrode has a shoulder width of substantially 4.7 μm.

8. An optical modulator comprising an input waveguide and an output waveguide coupled by first and second waveguide arms, the first and second waveguide arms have respective electrode structures comprising at least first and second electrodes for applying a modulating signal to the waveguide arms, the first and second electrodes being positioned on respective, separate, buffers; the buffers having dimensions such that the thermal coupling between the electrodes and the waveguides is substantially equal.

9. An optical modulator as claimed in claim 8 in which the distance between the first electrode and the first waveguide arm is substantially equal to the distance between the second electrode and the second waveguide ann.

10. An optical modulator as claimed in claim 9 in which the buffer layer shoulder width of the buffer layer of the first electrode has a width of substantially 12 μm.

11. An optical modulator as claimed in claim 10 in which the buffer layer of the second electrode has a shoulder width of substantially 4.7 μm.

12. An optical modulator as claimed in claim 9 in which the distance between the first and second electrodes is 12 μm-55 μm.

13. An optical modulator as claimed in claim 12 in which the distance between the first and second electrodes is 55 μm.

14. An optical modulator as claimed in claim 13 in which the electrode structure comprises a third electrode and the distance between the first electrode and the third electrode is 10-14 μm.
